(19) United States
(12) Patent Application Publication
(10) Pub. No.: US 2017/0022963 A1
(43) Pub. Date: Jan. 26, 2017

(54) Syngenergy Apparatus

(71) Applicant: Joseph A. DeBenedictis, Silver Spring, MD (US)

(72) Inventor: Joseph A. DeBenedictis, Silver Spring, MD (US)

(21) Appl. No.: 14/806,909

(22) Filed: Jul. 23, 2015

(51) Int. Cl. F03B 13/10; F03B 11/00; H02K 7/18

(52) U.S. Cl. CPC F03B 13/10; H02K 7/1807; F03B 11/00; F03B 17/04

(57) ABSTRACT

An apparatus and method for extracting energy from the synergistic effects of isolated, open and closed systems (Syngenergya) is described and is a form of renewable energy. The apparatus comprises a body located in a buoyant and non-buoyant medium, a pressure apparatus, and an energy transformer, collector, or generator coupled to the body, such that relative movement of the body provides energy; in one configuration, the body is exposed to a frictional force differential, buoyancy force differential, gravitational force differential, pressure force differential, directional inherent angular momentum, and a centripetal, centrifugal, or centrifical force causing movement of the body, providing energy to be extracted, converted, collected, transformed or otherwise be made useful.

### DESCRIPTION

The present invention relates to an apparatus and method for energy extraction from a moving body in a buoyant medium (water or other). In particular, the invention relates to a method and apparatus for use in a configuration that employs the syngenergistic effects of open, closed or isolated systems. One embodiment of the invention relates to a controlled buoyant body (the body itself acting as an isolated system with inherent angular momentum), deployed in a closed system (water medium) under the influence of another closed system (gravitational field) with catalytic effects enhanced by a third closed system (pressure chamber) in order to syngenergistically extract energy from the configured system that is adapted to use the energy to drive a generator, turbine, or other devices.

Energy extraction systems which use kinetic energy of moving bodies in water in any number of configurations to drive turbines are known.

Typically a buoyancy energy extraction system can be located in any number of areas that exhibit naturally occurring, artificial, or other buoyant medium (water, methane, etc.) sources. It would be desirable to produce an energy extraction system which has low environmental impact, is simple to manufacture and deploy, requires little supporting infrastructure, and which can be installed in a variety of locations. Additionally, gravitational sources can be found ubiquitously and universally (planets, moons, satellites, etc.) as can buoyant mediums (methane lake, or other buoyant mediums) for example.

It is one aim of the invention to provide a method and apparatus for extracting energy from syngenergistic actions of closed, isolated, or open systems that mitigate the drawbacks and inefficiencies of previously proposed buoyancy energy extraction systems. Other aims and objects of the invention will become apparent from reading the following description.

According to a first aspect of the invention, there is provided apparatus for extracting energy from a DeBenedictis (no axle, adjustable axle, compensating axle or any other type of movable axle) flywheel (body element), in a body of water (or other medium), the apparatus comprising a body element (flywheel) located in a buoyant medium; a coupled generator; such that relative movement of the flywheel and the coupled generator drives the generator; wherein the body comprises a frictional surface substantially immersed in a buoyant medium and in a gravitational field comprising at least one formation for promoting a frictional force on the body to cause movement of the body from the effects of the frictional force, the gravitational force, the buoyancy force, and the inherent angular momentum wherein such relative movement of the body drives the coupled generator.

The body of the apparatus may be referred to as a DeBenedictis flywheel (no axle, adjustable axle, compensating axle, or any other type of movable axle). In one configuration (of any number of configurations), it serves as an isolated system, possessing inherent angular momentum, spontaneously evolving toward thermodynamic equilibrium and maximum entropy, under the influence of open, closed, or isolated systems, and influencing adjacent open, closed or isolated systems, with a further aspect of continuous reciprocation to syngenergistically produce energy for utilization.

According to a second aspect of the invention, there is provided apparatus for extracting energy from the syngenergistic relationship of open, closed and isolated systems (gravitational field, buoyancy force, angular momentum, frictional force, pressure systems and any other system), to drive a coupled generator or any other energy producer, collector, transformer, or utility.

According to a third aspect of the invention, the apparatus provides a means of extracting energy from a body (mass/matter), with inherent angular momentum, exhibiting entropic disequilibrium, under the influence of syngenergistic effects of isolated, closed, or open systems, with catalytic effects of other adjacent systems. Systems that are not isolated may decrease in entropy, provided they increase the entropy of their environment by at least that same amount. Isolated systems, spontaneously evolve toward thermodynamic equilibrium and provide a mechanism for energy extraction.

According to a fourth aspect of the invention the apparatus embodies a renewable or continual reciprocal property allowing the potential energy of a body (mass/matter), an isolated system, in one closed system (gravitational field for example)) to convert to kinetic energy (through the spontaneous evolution toward thermodynamic equilibrium and maximum entropy), enter and engage or influence an adjacent closed system (buoyancy system for example), increasing the potential energy of the body (mass/matter) within that adjacent system, converting that potential energy to kinetic energy and returning (reciprocating) that kinetic energy to the first closed system, the process repeating continually until acted on by other forces, as systems that are not isolated may decrease in entropy, provided they increase the entropy of their environment by at least that same amount.

Thus the apparatus (in one configuration), may use the syngenergistic and reciprocating extraction of potential and kinetic energy in adjacent systems (isolated, open, closed, or other), and convert it to mechanical energy from a generator or other extraction and/or conversion method.

An important feature of the invention, in certain aspects, is the provision, in contrast to previous proposals that rely on fragile components and complex mechanisms, that, the embodiments of the present invention allow for the use of bodies which have substantial volume, and in simplicity of design, utilize syngenergistic principles to generate movement of the body.

According to a fifth aspect of the invention there is provided a method of extracting energy from a body in a buoyant medium (water, for example), the method comprising the steps of: providing a DeBenedictis flywheel in a syngenergistic relationship, and a coupled generator such that relative movement of the flywheel drives the generator.

Embodiments of the first through the fifth, aspects of the invention may include preferred and optional features of the first to the fifth aspects of the invention and vice versa. The Syngenergy apparatus can be located on land or on offshore platforms or other generating venues or plants.

The objective is to extract renewable energy from syngenergistic mechanisms. The main advantages of the system are its technical simplicity, its ability to utilize available forces to produce clean renewable energy, its expected capital and operating cost being a fraction of current energy proposals, its low carbon footprint, its minimal environmental impact, its minimal seabed or sea surface impact, its lack of visibility and noise. The concept is scalable based on the availability of locale or venue.

There is described, by way of example only, example embodiments of the invention with reference to the following drawings, of which:

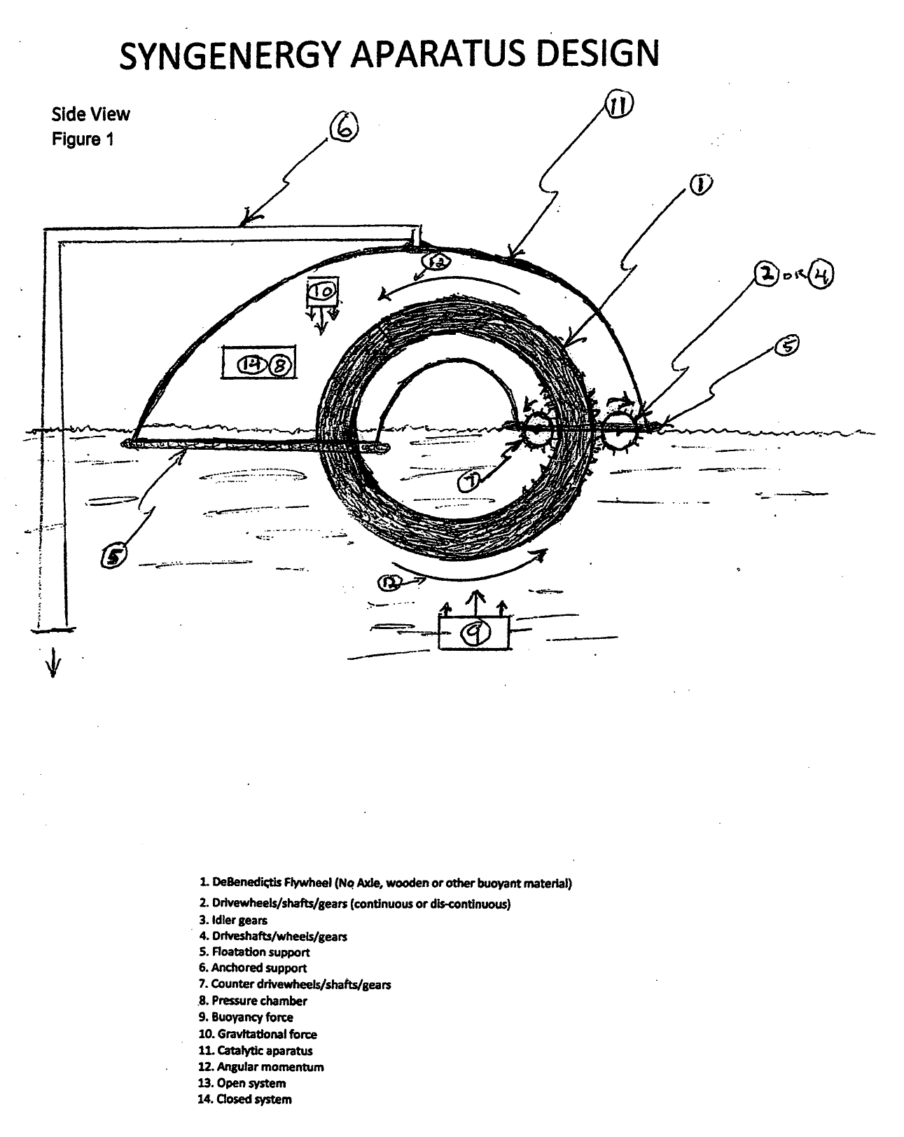

FIG. 1 is a schematic, side view of an apparatus, in one of many configurations. in accordance with a first embodiment of the invention;

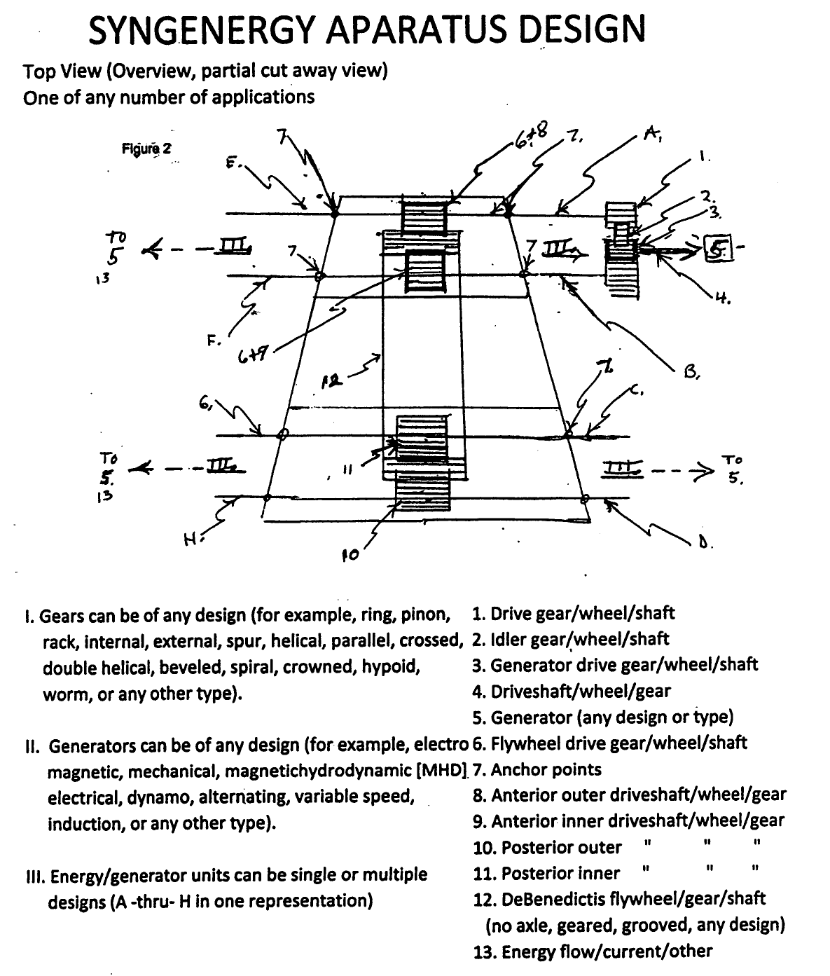

FIG. 2 is a schematic top view, overview, partial cut-away view, of FIG. 1 showing labeled elements;

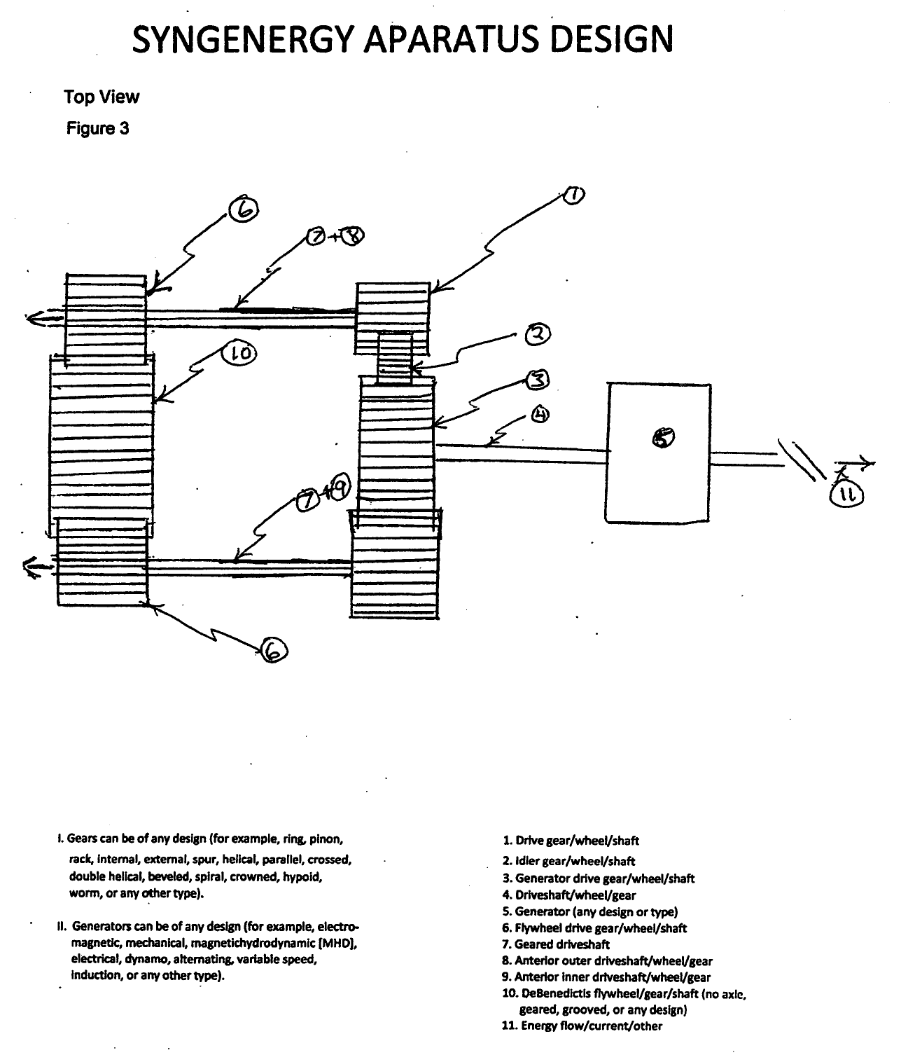

FIG. 3 is a schematic top view of one of many geared element configurations labeled in accordance with an embodiment of the invention;

Referring first to FIG. 1, there is shown an installation (one of any number of configurations), generally depicted, comprising the apparatus in accordance with an embodiment of the invention. The installation is shown deployed in a body of water, with a stationary anchored or telescoping (6) pressure chamber/catalytic apparatus (11), enclosing a DeBenedictis flywheel (1), with floating support (5), geared elements (2,4,&7), influenced by buoyancy force (9), gravitational force (10), angular momentum (12), in a closed system configuration (14), and pressure chamber (8).

Referring to FIG. 2, there is shown, in one configuration (of any number of configurations), a depiction of a drive gear (1), an idler gear (2), a generator drive gear (3), a drive shaft (4), a generator (5), flywheel drive gear (6), anchor points (7), anterior outer driveshaft (8), anterior inner driveshaft (9), posterior outer driveshaft (10), posterior inner driveshaft (11), DeBenedictis Flywheel (12), energy flow (13), and energy/generator units (III).

Referring to FIG. 3, there is shown one configuration (of any number of configurations), depicting a gear assembly with a drive gear (1), an idler gear (2), a generator drive gear (3), a driveshaft (4), a generator (5), flywheel drive gear (6), geared driveshaft (7), anterior outer driveshaft (8), anterior inner driveshaft (9), DeBenedictis Flywheel (10), and energy flow (11).

Referring to FIG. 3, in one depiction, the generator (5) is one that converts mechanical rotational energy into electrical energy. The generator may be of any type generator. The generator element depicted (1-13) is one of many configurations of a suitable gearing system for controlling the Syngenergy production. On the anterior outer driveshaft (8) side, an idler gear (2) is utilized to synchronize the rotational properties with the anterior inner driveshaft (9). The anterior inner driveshaft (9) and the anterior outer driveshaft (8) are synchronized by the idler gear (2) to drive the driveshaft (4) unidirectionally that allows the generator (5) convert the Syngenergy produced into useful energy/current/electricity and flow (11).

One depiction (FIG. 1) is of an apparatus that is one of many possible applications in that the apparatus can be a surface installation, semi-submersible, submersible, or other.

The apparatus is functional in any universal system (open, closed, isolated, or other system to be discovered in the cosmos, universe, or multi-verse) or vacuum, that exhibits a gravitational field of any magnitude, a buoyant medium of any sort, a body that exhibits any form of angular momentum, in a syngenergistic relationship.

It will be understood by anyone skilled with the basic elements of physics and may vary in different embodiments of the invention, and example embodiments that are illustrated with reference to FIGS. 1 to 3.

An energy storage system of this embodiment is just one method (of many possible applications) of converting and storing energy generated by the apparatus, and other methods may be used in alternative embodiments. For example, the apparatus could operate a compressed air or gas energy storage system, or in another embodiment the apparatus could include a transmission line for transmission of electrical energy to a remote storage system or transmission grid.

Electrical energy generated by embodiments of the invention could be connected to a grid system, or alternatively could be used locally to the installation. For example, the electrical energy could be used to store energy in another form. Alternatively, the energy could be used directly to provide power for domestic or industrial use.

This invention relates to the controlled deployment of a DeBenedictis flywheel (no axle or adjustable axle), in a buoyant medium, under the influence of a gravitational field, with or without the use of a catalytic apparatus in order to take advantage of the syngenergistic effects of open, closed, isolated, or other systems in order to extract energy, in one embodiment, from the inherent angular momentum of the flywheel (body), and use the mechanical energy to drive a generator.

The invention provides an apparatus and method for extracting energy from a body or matter in a buoyant medium. The apparatus comprises a body or matter, located in a buoyant medium, a generator; and gears coupled to the generator such that relative movement of the body/matter, drives the generator. In one configuration, the body comprises an axle-less flywheel oriented substantially in the buoyant medium, under the influence of a gravitational field, in a pressure chamber or other catalytic system and has at least one formation for promoting a frictional force on the body. The frictional force causes movement of the body and under the influence of syngenergistic and interactive properties associated with open, closed, isolated or other systems, along with effects of inherent angular momentum, results in relative movement of the flywheel, (body, matter or other) to drive the generator.

In one embodiment. the apparatus is comprised of a DeBenedictis flywheel, comprising at least one formation which promotes movement of the flywheel within a pressure apparatus (chamber), from the syngenergistic effects of; a gravitational field, a buoyant medium, a catalytic component of the pressure chamber, a frictional component, an angular momentum component, and a disequilibrium component. The flywheel is coupled to a generator such that movement of the flywheel drives the generator. The present invention and its embodiments provide an alternative energy extraction system for use in many applications which has low environmental impact, is simple and inexpensive to manufacture and deploy, requires little supporting infrastructure, and which can be installed in a variety of locations.

Combinations of features other than those expressly claimed are within the scope of the invention.

The invention claimed is:

1. An apparatus for extracting energy from the synergistic effects of isolated, and/or open, and/or closed systems, and their influence on matter/mass (or a body, in one configuration), in a buoyant and non-buoyant medium, the apparatus comprising: a body in a buoyant medium and a non-buoyant medium, a pressure apparatus, and an energy transformer, collector or generator, coupled (in any configuration) to the body such that the relative movement of the body provides energy for transforming, collecting, generating and/or use; the body being acted on by syngenergistic action of, a buoyancy force, a gravitational force, a pressure force, a frictional force and a directional inherent angular momentum force; moves from one closed system (buoyancy) to another closed system (gravity) under the influence of a third closed system (pressure apparatus), with a differential frictional force (positive and/or negative drag), providing movement of the body, and the body, being composed of matter, oscillates continually (in entropic disequilibrium) between the two closed systems, exhibiting a renewable syngenergistic energy system that provides energy for transformation, collection, generating, or multiple generators and operation or use, and continues except when acted on by an external force.

2. The apparatus as claimed in claim 1, wherein the at least one formation comprises a surface for promoting the positive and/or negative frictional (drag) force on the body to cause rotational movement of the body.

3. The apparatus as claimed in claim 1, wherein the body is suspended in a buoyant medium, and the body moves in one representation in a circular direction.

4. The apparatus as claimed in claim 1, wherein the body is coupled, in any configuration, to the collector, transformer, or generator, and the body moves to produce energy that is transformed, collected, generated or otherwise useful.

5. The apparatus as claimed in claim 1, wherein the body can comprise multiple formations.

6. The apparatus as claimed in claim 1, wherein the at least one formation is a part of a drag or frictional element disposed on the body.

7. The apparatus as claimed in claim 6, wherein the drag element defines a differential frictional force such that the body moves.

8. The apparatus as claimed in claim 7, wherein the body is influenced and moves through and between configured closed systems.

9. The apparatus as claimed in claim 1, wherein at least one formation is directionally configured such that a maximal frictional force, a maximal buoyancy force, a maximal gravitational force and a maximal directional angular momentum is exerted on the body in a direction and a minimal frictional, buoyancy, and gravitational force is exerted on the body in an opposite direction.

10. The apparatus as claimed in claim 1, wherein at least one formation is configured to promote movement of the body in a circular direction.

11. The apparatus as claimed in claim 1, wherein the body is buoyant.

12. The apparatus as claimed in claim 1, wherein the body in one representation is substantially cylindrical.

13. The apparatus as claimed in claim 1, wherein the body in one configuration, has ridges on either end, and an axial void or hole. The ridges can serve as rudders to hydrodynamicly increase or decrease drag as indicated and control directional movement.

14. The apparatus as claimed in claim 1, wherein the body in one configuration is substantially spool shaped.

15. The apparatus as claimed in claim 1, further comprising a plurality of elements configured together to form a pressure system or chamber, a body of buoyant matter, a coupling device, a buoyant medium, and a non-buoyant medium, wherein each element respectively contributes to the design, for syngenergistic energy production.

16. The apparatus as claimed in claim 1, wherein the plurality of the elements is part of a modular system of components.

17. The apparatus as claimed in claim 1, further comprising a plurality of elements deployed in an array.

18. The apparatus as claimed in claim 1, further comprising a support structure for supporting the pressure apparatus.

19. The apparatus as claimed in claim 1, wherein a support structure comprises at least one of many configurations (stationary, telescoping, non-telescoping, or otherwise adjustable), attached to or located within the buoyant medium, apart from the buoyant medium, or suspended in the buoyant medium.

20. The apparatus as claimed in claim 1, wherein the support structure comprises an apparatus to allow the pressure differentiator (chamber or other entity) to interact catalytically, or otherwise, with the element generating the Syngenergy.

21. The apparatus as claimed in claim 1, wherein the apparatus comprises a mechanism for transfer of energy (mass/matter), between two closed, open, or isolated systems.

22. The apparatus as claimed in claim 1, wherein the apparatus provides for continuous motion.

23. A method of extracting energy from synergistic effects of two or more isolated, closed or open systems, whereby one system in entropic disequilibrium acts synergistically with another system (or multiple systems) in entropic disequilibrium syngenergistcally, such that their respective entropic disequilibrium states allow for a body (mass/matter) or bodies to interact with each system or systems, allowing for movement of the body between the closed systems and for the extraction of energy. The entropic disequilibrium of each system spontaneously evolves toward thermodynamic equilibrium, the configuration of maximum entropy, according to the second law of thermodynamics.

24. The method as claimed in claim 1, further comprises a third (or more) closed system providing various catalytic effects such that the initiation of and enhancement of entropic disequilibrium allows for movement of a body between two closed isolated or open systems.

25. The method as claimed in claim 1, further comprising driving a generator through any number of adaptation of gears, wheels, or other devices.

26. The method as claimed in claim 1, further comprising driving a second (or more) generator/s through any number of configurations of mechanisms to enhance and/or extract energy.

27. The method as claimed in claim 1, further comprising a method for multiplying or exponentially enhancing the syngenergistic effect through any configuration of gears, idlers, adapters, drive wheels, flywheels, drive shafts, or other mechanisms.

28. The method as claimed in claim 1, further comprising continuous syngenergistic effects or those that employ any number of flywheels.

29. The method as claimed in claim 1, wherein at least one formation defines a continuous moving body between isolated, closed, or open systems in entropic disequilibrium, with catalytic effects of additional isolated, closed or open systems, syngenergistically producing energy.
